(19) United States
(12) Patent Application Publication
(10) Pub. No.: US 2003/0196741 A1
(43) Pub. Date: Oct. 23, 2003

(54) Textile joint reinforcement and associated method

(75) Inventors: Roger A. Burgess, Long Beach, CA (US); James D. Mundloch, Florissant, MO (US); Steven P. Wanthal, St. Charles, MO (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/428,604

(22) Filed: May 2, 2003

Related U.S. Application Data
(62) Division of application No. 10/117,013, filed on Apr. 5, 2002.

(51) Int. Cl. B32B 7/08

(52) U.S. Cl. 156/92

(57) ABSTRACT

A three dimensional textile joint reinforcement joins and reinforces a composite panel and a support structure. The composite panel includes lamina of textile fibers in the plane of the panel. The joint reinforcement is attached to the composite panel by staples. The support structure, which is typically perpendicular to the plane of the composite panel, is also attached to the joint reinforcement. Out of plane forces act upon the assembled structure and the joint reinforcement transfers out of plane loads between the support structure and the composite panel. The staples provide transfer of load to the plane of the textile fibers in the composite panel, where the composite panel is strongest.

### FIELD OF THE INVENTION

The present invention relates to composite textiles assembly, and, more particularly, to reinforcing three dimensional textile joints and support structures in a composite panel.

### BACKGROUND OF THE INVENTION

The use of composite structures in the aerospace industry has become more and more prevalent due to the desirable properties of composites, especially low weight, high strength and stiffness, resistance to corrosion, and damping characteristics among other properties. Composite materials are now being used for aircraft wings, horizontal and vertical stabilizers, nose and tail cones, and other aircraft structural elements. The advantageous properties of composites have increased aircraft performance benefits, including increased range, decreased fuel consumption, and greater payload. Added performance benefits guide the use of composites throughout the aerospace industry. However, the primary shortcoming of composites has been high cost, which has prohibited the use of composite materials in low cost applications. Cost is now the primary barrier to the use of composite materials in additional applications and the aerospace industry is continuing to explore ways to improve the cost of composite manufacturing while maintaining the performance benefits of composite materials. In particular, assembly of composite structures, especially three dimensional composite structures, has been a significant cost burden in the aerospace industry.

The assembly of a composite aircraft wing provides an example of the current cost burden. The outer skin of an aircraft wing is typically an assembly of composite panels. Composite panels typically include adhesively bonded lamina of textile fiber and other core materials. The panels are sometimes pre-impregnated with the organic resin matrix (prepreg) and cured in an autoclave, or dry fibers assembled and laid up in a resin transfer mold (RTM) or a vacuum assisted resin transfer mold (VARTM) process, infused with the organic resin and cured in an oven. The composite panels are typically assembled prior to curing, while they are in their flexible textile form. In the final cured product they become an integral rigid structure.

Composite panels exhibit great strength in the X-Y plane, that is the plane of orientation of the fibers, however, they are susceptible to significant “out of plane” loads at the far weaker bond line between lamina which can cause separation of the plies at relatively low loads. Therefore, the composite panels require support and reinforcement, typically in the direction perpendicular to the plane of the orientation of the fibers. Adhesives are typically used between the plies but lack strength to overcome many large out of plane loads. Out of plane reinforcement of large composite structures is often achieved with support structures. The stiffeners, such as ribs, stringers, intercostals, and spars, are generally joined to the composite panel by adhesives, co-cured, or welded. Unfortunately, attempts to strengthen the adhesives, cured thermosetting resins, or thermoplastic welds have proven unsatisfactory when confronted with significant out of plane forces that some aircraft structures typically must endure.

Traditionally, mechanical fasteners, such as bolts, rivets, etc., have been used in the aerospace industry for joint reinforcement in both planar, two dimensional joints, and three dimensional joints for both metal structures and composite structures. Mechanical fasteners, however, are generally, metallic and bulky, which causes at least three problems. First, they contribute additional weight. Second, metallic fasteners contribute undesirable thermal and electrical properties. Third, drilling and installing fasteners increase cost. Most importantly, mechanical fasteners are most often required to fasten a composite panel through the outer mold line of the panel, thus adding uneven irregularities to the outer skin of the aircraft. Irregularities on the outer mold line produce undesirable characteristics. For example, post-curing treatments are often required prior to assembling the structure on an aircraft. Some treatments include methods to reduce the electromagnetic reflective properties of the aircraft skin, known in the art as low observable treatments. Avoiding irregularities on the outer mold line greatly improves the ability to provide such treatments. Therefore, mechanical fasteners that penetrate the outer mold line are undesirable.

Preferred methods of attaching support structures without mechanical fasteners include stitching joint reinforcements to the composite panel. Stitching reduces weight compared to mechanical fasteners and stitching materials are readily available and compatible with the composite textile and the curing process. Stitching has not, however, been a low cost joint reinforcement solution. Stitching large and geometrically irregular composite assemblies requires expensive computer controlled robotic stitching machines. Additionally, large robotic stitching machines are difficult to use in confined and limited areas.

Another preferred joint reinforcement that avoids the use of traditional mechanical fasteners includes the use of Z-pins. Z-pins are driven into the composite panel with an ultrasonic energy pin insertion tool that penetrates the lamina moving aside fibers to insert the pins. The pins protrude beyond the composite panel and an opposed surface, such as the flange of a stiffener that is to be connected to the composite panel, is placed thereupon. A pressure plate is then used to drive the end of the pin that protrudes beyond the composite panel into the opposed surface. Thus, the pins reinforce the stiffener and composite junction. The pins are heated under pressure during the curing process and at least partially molten such that the pins become integral with the resin upon curing, thus creating a permanent joint reinforcement between the stiffener and the composite panel. Again, added cost is a primary disadvantage to Z-pin insertion, because ultrasonic pin insertion tools are quite expensive. Additionally, Z-pin insertion tools are too large to insert Z-pins into confined and limited areas.

In efforts to cut cost while maintaining high performance standards of composite structures, the current trend in the aerospace industry is to integrate composite assemblies, allowing for fewer parts. This leads to larger composite parts with complex molded features, more interface requirements, greater structural depth, and stringent dimensional control requirements. Consequently, many in the aerospace industry are moving away from the three dimensional composite structures made with prepregs and cured in an autoclave to integral reinforcements and attachments laid up in a dry condition then cured in an oven through the vacuum assisted resin transfer mold process. Z-pins, previously the preferred method of reinforcement, have particularly proven difficult to be used in dry preforms where there is no resin to hold them in place after insertion. Trials have shown that Z-pins add excessive bulk when inserted into dry preforms, and this bulk is difficult to remove during cure.

Thus the primary limitations in joint reinforcement and composite assembly are cost, the ability to reinforce prepregs and non-prepregs alike, and the ability to attach joint reinforcements in confined and limited spaces. Therefore, there is a need for low cost joint reinforcement of composite textile panels without sacrificing performance of the composite materials. More particularly, there is a need for joint reinforcement in confined and limited areas in both prepreg composite textiles and non-prepreg composite textiles.

### SUMMARY OF THE INVENTION

A textile joint reinforcement and a method for reinforcing a composite textile joint are therefore provided for assembly of high performance complex shaped composite structures. The textile joint reinforcement includes a flange, which is adapted to be mechanically fastened to a composite structure, such as a composite panel, with at least one staple. The textile joint reinforcement also includes a load bearing member which extends outwardly from the flange. The load bearing member is adapted to be connected to a support structure, and as such, provides a transfer of load between the composite structure and the support structure through the joint reinforcement. The load bearing member and the flange are both preferably made from a single contiguous three dimensional textile fiber structure, thereby enhancing one strength and load bearing characteristic of the resulting joint.

The textile joint reinforcement of one advantageous embodiment of the present invention includes a pair of load bearing members, both of which may be attached to a support structure and adapted to transfer load thereto. The pair of load bearing members may be constructed in a parallel spaced apart relation to one another, and thus the area between the parallel load bearing members defines a slot. The slot may advantageously receive an edge of the support structure for attaching to each of the parallel load bearing members, such as by means of an adhesive.

According to another embodiment of the present invention, a reinforced joint is provided that includes a composite panel with a textile joint reinforcement. The textile joint reinforcement includes a flange disposed upon the composite panel and a load bearing member extending outwardly from the flange. Staples extending through the flange mechanically connect the flange of the textile joint reinforcement to the composite panel. The staples may extend through the flange immediately adjacent to the load bearing member for providing the most efficient load transfer between the composite panel and the support structure. In one embodiment, one staple may be formed of a thermoplastic resin composite. A support structure such as a spar, rib, intercostal, or stringer is connected to the load bearing member, such that the textile joint reinforcement transfers load between the composite panel and support structure.

The reinforced joint of one embodiment includes a textile joint reinforcement wherein the flange and the load bearing member are comprised of a contiguous three dimensional textile fiber structure. In addition, the composite panel, textile joint reinforcement, and support structure may be preimpregnated with thermosetting resin, known in the art as prepreg.

One advantageous embodiment of the joint reinforcement of the present invention includes a textile joint reinforcement with a pair of load bearing members, both outwardly extending from the flange of the textile joint reinforcement. Each of the pair of load bearing members may be connected to the support structure, and thus each transfer load between the composite panel and support structure. In one embodiment, the pair of load bearing members are parallel to one another and thus define a slot therebetween. The load bearing members are adapted to receive an edge of the support structure inserted into the slot. An adhesive applied within the slot defined by the load bearing members may be used for securing the edge of the support structure to the pair of load bearing members. For further reinforcement, one embodiment includes attaching the flange to the composite panel with at least one staple inserted into composite panel from within the slot defined by the pair of load bearing members.

With respect to the method of reinforcing a composite joint, a textile joint reinforcement is initially positioned upon a composite panel and is stapled thereto. The textile joint reinforcement comprises a flange and a load bearing member extending outwardly from the flange. As such, the textile joint reinforcement is generally positioned such that the flange overlies at least a portion of the composite panel and the load bearing member extends outwardly from the composite panel. Thus, the flange may be stapled to the composite panel at an area adjacent to the load bearing member. The method then further includes attaching a support structure to the load bearing member.

In one aspect of the method of the present invention, the textile joint reinforcement has two parallel load bearing members spaced apart defining a slot therebetween. A support structure is inserted into the slot and is adhered therewithin. The joint reinforcement may also be stapled to the composite panel in the slot between load bearing members for further joint reinforcement.

Therefore, a joint reinforcement and method of composite assembly joint reinforcement with staples is provided. The lower cost of staples and stapling mechanisms provide a more economical approach to composite assembly without sacrificing structural performance requirements. The use of staples allow access to small areas and difficult areas of access previously unavailable to fasteners and Z-pins. Additionally, staples are easily inserted into prepegs and non-prepegs alike, thus allowing greater flexibility of molding processes for composite assemblies employing the joint reinforcement of the present invention. It will also be noted by one of ordinary skill in the art that the joint reinforcement and method advantageously reduce delamination in composite structures, thus increasing damage tolerance of the composite assembly.

### BRIEF DESCRIPTION OF THE DRAWINGS

Having thus described the invention in general terms, reference will now be made to the accompanying drawings, which are not necessarily drawn to scale, and wherein:

FIGS. 1 and 2 are end views of a “T” shaped joint reinforcement stapled to a composite panel according to one embodiment of the present invention;

FIGS. 3 and 4 are end views of a “pi” shape joint reinforcement stapled to composite panel according to one embodiment of the present invention;

FIG. 5 is an end view of a “pi” shape joint reinforcement stapled to a composite panel according to one embodiment of the present invention;

FIG. 6 is a plan view of staples attaching a “pi” shaped joint reinforcement to a composite panel according to one embodiment of the present invention; and

FIG. 7 is a perspective view of an assembled joint reinforcement and composite panel according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

According to the present invention, an apparatus and method for composite textile joint reinforcement is provided. As known to those skilled in the art, composite textile structures are strengthened against out of plane forces by three dimensional support structures in a variety of manners. Support structures that are often used to reinforce composite structures include spars, ribs, intercostals, and stringers. Likewise, a variety of joint reinforcement structures are used for reinforcing the connection between the support structure and the composite structure. The present invention is suitable for connecting numerous types of joint reinforcement structures to many different support structures.

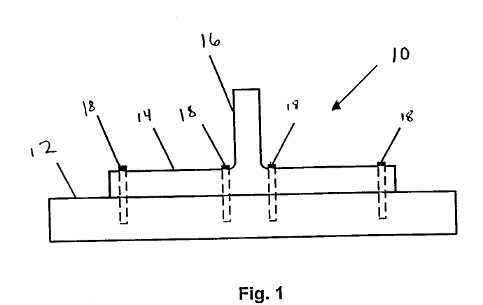

Referring now to FIG. 1, a three dimensional composite preform joint reinforcement 10, shaped like a “T”, is depicted positioned upon a composite panel 12 preform. The term preform refers to composite structures prior to molding and curing to the final rigid composite structure, known in the art as C-stage. The term composite refers to an organic resin matrix of textile fibers such as fibers formed of glass, carbon, boron, Kevlar®, etc. In the course of curing, the organic matrix solidifies about the fibers to form an integral rigid structure. Many curing processes are well known to those skilled in the art and require little explanation to describe the present invention. As will be apparent, however, the present invention is applicable to preforms that are impregnated with organic resin matrix prior to assembly (prepreg) and those that are assembled dry and then impregnated and cured in a resin transfer mold (RTM) process.

In this particular embodiment, the joint reinforcement 10 includes a flange 14 and a load bearing member 16. While the illustrated joint reinforcement is symmetrical relative to the load bearing member by including a pair of oppositely extended flanges, the joint reinforcement may have other shapes and may include only a single flange, if desired. The joint reinforcement 10 is preferably made from a single contiguous textile fiber structure comprising both the flange 14 and the load bearing member 16. As such, the joint reinforcement is an integral structure with increased strength as a result of the contiguous textile fibers extending through both the flange and the load bearing member. The fiber structure of the flange 14 is designed to be of a suitable density, such as three dimensional woven or braided laminate, or a stitched subassembly, to receive and hold staples inserted at a later step in the assembly of the composite structure. In addition, the fiber structure of both the flange and the load bearing member 16 is designed to be of a suitable strength to reinforce and transfer load between a support structure 20, FIG. 2, and the composite panel 12, once molded and cured. In the preform stage, the joint reinforcement 10 is flexible, however for purposes of illustration FIGS. 1 and 2 depict the flange 14 and load bearing member 16 as they will ultimately be molded and cured to C-stage.

As shown in FIG. 1, the joint reinforcement 10 overlies the composite panel 12. Typically, a composite panel 12 includes plural plies of textile fibers, either woven or non-woven, joined by adhesive. Many composite panels often include additional elements not shown, such as foam cores, honeycomb composite cores, etc. A composite panel 12 is exceptionally strong in the plane of the textile fiber, however, the shear area between plies is far less strong and susceptible to interlaminar shear forces, which occur from out of plane forces acting upon the composite panel 12. Therefore, a support structure 20 is attached to the composite panel 12, typically oriented in the direction perpendicular to the plane of the composite panel 12. The joint reinforcement 10 joins the support structure 20 to the composite panel 12. The composite panel 12, as shown, is substantially planar for purposes of illustration, but irregular shapes are common and the description of the embodiments illustrated herein will facilitate the use of the present invention with irregularly formed composite panels by those skilled in the art.

The joint reinforcement 10 is shown positioned over the composite panel 12 for placement along an area of the composite panel 20 requiring reinforcement. The flange 14 overlies the composite panel 12 and the load bearing member 16 extends outwardly from the flange 14, and consequently extends outwardly from the composite panel 12. Once properly positioned upon the composite panel 12, the flange 14 is attached to the composite panel 12 with staples 18. The staples 18 are preferably inserted at an area nearest the load bearing member 16, which is the critical tension point of load transfer between the composite panel 12 and the load bearing member 16. Additional staples 18 may be inserted further from the load bearing member 16 to add strength to the flange 14 fastening to the composite panel 12. Upon assembly, the assembled structure is prepared for curing to C-stage.

FIG. 2 illustrates a support structure 20 connected to the load bearing member 16. The support structure 20 is any structure suitable to receive and transfer out of plane loads affecting the composite panel 12. These include the class of stiffeners commonly used on wing structures to support composite panels such as spars, stringers, intercostals, and ribs. Alternatively, these may include fuselage structures such as keels, bulkheads, and longerons. The support structure 20 is typically oriented in a direction perpendicular to the plane of the composite panel 12.

The final structure includes a composite panel 12 and support structure 20 joined by the “T” shaped three dimensional joint reinforcement 10 preform. An edge of the support structure 20 is attached to the load bearing member 16. The support structure may be attached to the load bearing member in various manners, such as by staples as described in conjunction with the attachment of the flange to the composite panel. In one embodiment, however, an adhesive, such as epoxy film adhesive, is placed between the load bearing member 16 and support structure 20 to attach the support structure 20 to the load bearing member 16. Alternatively, load bearing member 16 and support structure 20 may be bolted together. The assembled structure therefore provides out of plane support for the composite panel 20. Out of plane forces acting upon the composite panel and assembled structure are transferred between the support structure 20 via the joint reinforcement 10 and staples 18 to the in-plane dimension of the composite panel 20, where the panel is strongest.

For purposes of illustration, the present invention is described in conjunction with a generic planar support structure 20 attached to a “T” shaped three dimensional joint reinforcement 10, as in FIG. 1. As will be described in more detail below, FIG. 4 illustrates a “pi” shaped three dimensional joint reinforcement 30 connected to a generic planar support structure 40. In other cases, however, the flange and load bearing members of the joint reinforcement are integral to the support structure and are variously shaped. For example, a typical I-beam spar would include a flange, that is one end of the “I”, attached to a composite panel and a load bearing member, that is the middle part of the “I”, extending outwardly therefrom. Many other well known stiffeners are variously shaped, but at least include elements integral to the support structure corresponding to the flange and load bearing member of the present invention. In other cases, a support structure may be distinct from the joint reinforcement and then attached to the joint reinforcement by stitching, fasteners, or adhesives. Often separate support structures are co-cured with the joint reinforcement and composite panel in order to achieve an integral structure after curing. Nevertheless, the description herein conveys principles relating to an illustrative preform assembly, and these principles are generally applicable to most composite textile panel assemblies and related methods of assembly. Therefore, the method for reinforcing composite structure joints can be employed in conjunction with other joint reinforcement structures and support structures without departing from the spirit or scope of the present invention.

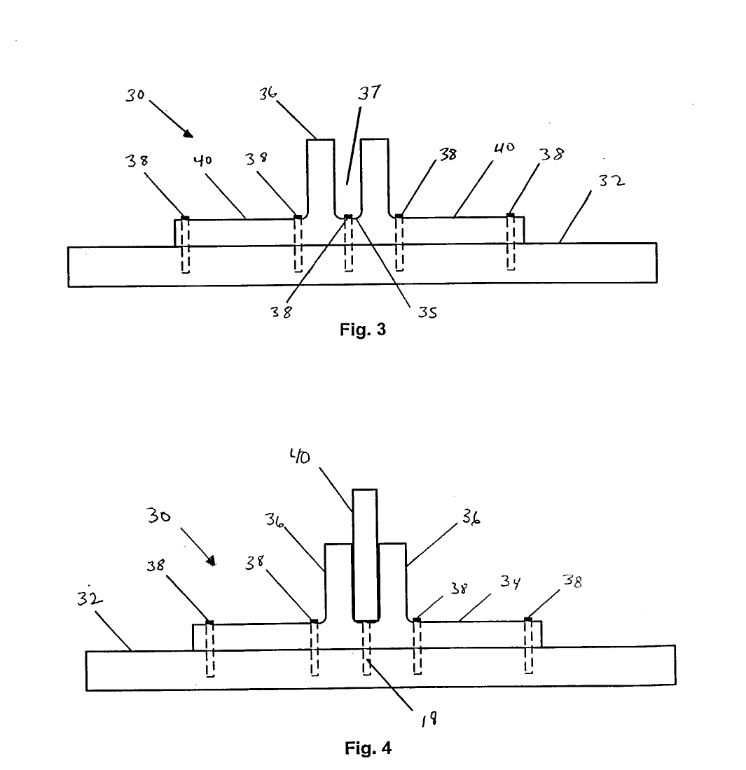

Referring now to FIG. 3, another embodiment of a three dimensional joint reinforcement 30 preform in a “pi” shape overlies a composite panel 32. The joint reinforcement 30 is of suitable strength and density for receiving and securely gripping staples 38 inserted through the flange 34 to attach the joint reinforcement 30 to the composite panel 32. The “pi” shape joint reinforcement 30 preform provides a pair of load bearing members 36 extending outwardly from the flange 34. Preferably, the entire joint reinforcement 30 is one contiguous fiber structure as described above. In this embodiment, the load bearing members 36 are parallel to each other and consequently provide a slot 37 therebetween, at the base of the slot 37 is the clevis 35. The slot 37 is necessarily defined in length and width to receive a corresponding support structure 40, FIG. 4, for attachment to the interior surfaces of the load bearing members 36.

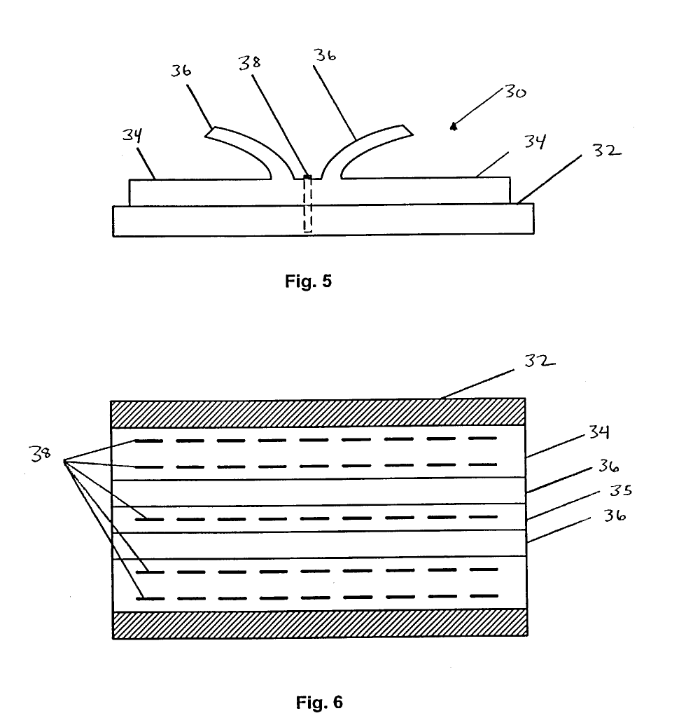

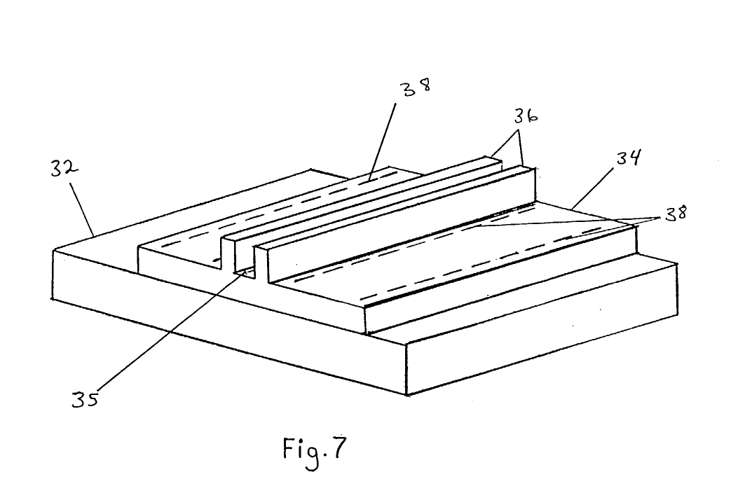

Staples 38 join the “pi” joint reinforcement 30 to the composite panel 32. The staples 38 are preferably concentrated at an area of the flange 34 nearest one of the load bearing members 36, in order to reinforce the area nearest the critical tension point between the composite panel 32 and the particular load bearing member 36. Stapling is also desired between the load bearing members 36 in clevis region 35 where the joint reinforcement 30 transfers applied loads between the support structure 40 and composite panel 32. These areas are typically inaccessible to other reinforcement methods Additional staples 38 may be inserted further from the load bearing members 36 to add strength to the fastening of the flange 34 to the composite panel 32. FIGS. 6 and 7 are a plan view and a perspective view, respectively, illustrating staples 38 positioned along the flange 34 and in the slot of the joint reinforcement 30. The staples 38 are regularly spaced at a predetermined interval according to the required load support at the reinforcement in relation to the load capacity of the staples 38. The stapling of the joint reinforcement 30 to the composite panel 32 is accomplished prior to curing while the preform is flexible. Therefore, the load bearing members 36 can be laid back, as illustrated in FIG. 5, to allow insertion of the staple gun (not shown) within the clevis 35 between the load bearing members 36. Additionally, the relatively small size of most staple guns facilitates insertion of the staples 38 in to the flange 34 closest to the intersection to one of the load bearing members 36.

The final structure includes a composite panel 32 and support structure 40 joined by the “pi” shaped three dimensional joint reinforcement 30 preform. An edge of the support structure 40 is inserted into the slot 37 between the pair of load bearing members 36. An adhesive is placed between the load bearing members 36, typically prior to the insertion of the edge of the support structure, to attach the support structure 40 to the load bearing members 36. The resulting structure provides out of plane support for the composite panel 32. Out of plane forces acting upon the assembled structure are transferred between the support structure 40 via the joint reinforcement 30 and staples 38 to the in-plane dimension of the composite panel 32, where the panel 32 is strongest.

Referring again to FIGS. 1 and 3, the staples 18, 38 of both illustrated embodiments are preferably composite staples made from a thermoplastic resin or thermoset material with reinforcing fibers, which are thermally compatible with the curing process. Staples 18, 38 provide a cost saving advantage because they may be inserted by commercially available staple guns. Commercially available staple guns are far less expensive than other conventional attaching mechanisms, such as ultrasonic Z-pin insertion tools and robotic stitching machines. Additionally, the comparatively smaller dimensions of staple guns advantageously allow insertion of staples 18, 38 into limited and confined areas not otherwise accessible by conventional attaching mechanisms. Staple reinforcement in the limited and confined areas, such as the clevis region 35 between load bearing members in a “pi” shaped joint reinforcement 30 preform, enhances the structural integrity of the joint reinforcement 30. Composite staples, in particular, avoid adding undesirable weight and conductivity found in metal staples, while matching the strength of metal staples. One example of a composite staple includes a staple produced by Utility Composites, Inc., of Round Rock, Tex., and described in U.S. Pat. No.6,168,362 to Tucker at al.

The dimensions of the staples 18, 38 must be chosen corresponding to the thickness of the respective composite panel 12, 32 and joint reinforcement 10, 30 preforms. The staples 18, 38 are inserted into the respective composite panel 12, 32 to transfer load between the respective support structure 20, 40 and the plies of the composite panel 12, 42 through the joint reinforcements 10, 30. However, the staples 18, 38 should not exit to the opposite side of the composite panel 12, 42 generally known as the outer mold line. The outer mold line typically comprises the skin of the assembled composite structure, such as the outer skin of an aircraft. Irregularities and disturbances on the outer mold line of composite structures produce undesirable properties, as described in the background section above. Therefore, the length of the staples 18, 38 must be less than combined width of each composite panel 12, 42 and flange 14, 34, but long enough to adequately transfer the applied loads to the surrounding composite textile. Staples would generally penetrate through the entire flange 14, 34 and into the panel 32 a distance roughly equal to the flange thickness or at least several plies deep at a minimum.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A reinforced joint, comprising:
a composite panel;
at least one textile joint reinforcement, comprising:
a flange disposed upon at least a portion of the composite panel; and
a load bearing member extending outwardly from the flange;
a plurality of staples extending through the flange of said textile joint reinforcement and into said composite panel for mechanically connecting the textile joint reinforcement to the composite panel; and
a support structure connected to the load bearing member, wherein the textile joint reinforcement transfers load between the composite panel and support structure.

2. The reinforced joint of claim 1, wherein the composite panel, textile joint reinforcement, and support structure are impregnated with a thermosetting resin.

3. The reinforced joint of claim 1, wherein the staples are comprised of a thermoplastic resin composite.

4. The reinforced joint of claim 1, wherein the support structure is comprised of a composite material.

5. The reinforced joint of claim 4, wherein the support structure comprises a stiffener selected from the group consisting of a spar, an intercostal, a rib, and a stringer.

6. The reinforced joint of claim 4, wherein the support structure comprises a stiffener selected from a group consisting of a keel, a bulkhead, and a longeron.

7. The reinforced joint of claim 1, wherein the textile joint reinforcement is comprised of a contiguous three dimensional fiber structure.

8. The reinforced joint of claim 1, wherein the flange is fastened to the composite panel with at least one staple adjacent to the load bearing member.

9. The reinforced joint of claim 1, further comprising a pair of outwardly extending load bearing members.

10. The reinforced joint of claim 9, wherein said pair of load bearing members extend in parallel to one another and are spaced apart from one another to define a slot therebetween.

11. The reinforced joint of claim 10, wherein an edge of support structure is inserted to the slot defined by pair of load bearing members.

12. The reinforced joint of claim 11, further comprising an adhesive within slot defined by the load bearing members for securing the edge of the support structure to said pair of load bearing members.

13. The reinforced joint of claim 10, further comprising at least one staple inserted into composite panel from within slot defined by the pair of load bearing members.

14. The reinforced joint of claim 1, wherein the support structure is integral to the joint reinforcement.

15. A method of forming a textile joint reinforcement for a composite structure, comprising:
positioning a textile joint reinforcement upon a composite panel, wherein the textile joint reinforcement comprises a flange and a load bearing member extending outwardly from the flange, and wherein positioning the textile joint reinforcement comprises positioning the textile joint reinforcement such that the flange overlies at least a portion of the composite panel and the load bearing member extends outwardly from therefrom;
stapling the flange of the textile joint reinforcement to the composite panel; and
attaching a support structure to the load bearing member.

16. The method of claim 15, wherein the step of stapling the flange to the composite panel includes stapling through the flange at an area adjacent to the load bearing member.

17. The method of claim 15, wherein the textile joint reinforcement has two parallel load bearing members and the step of attaching the support structure further comprises adhering an edge of support structure within a slot between the two parallel load bearing members.

18. The method of claim 17, wherein the step of stapling further comprises stapling the joint reinforcement to the composite panel from a position between the load bearing members.
